(19) United States
(12) Patent Application Publication
(10) Pub. No.: US 2016/0257281 A1
(43) Pub. Date: Sep. 8, 2016

(54) AIRBAG MODULE AND ITS USE

(71) Applicant: GM GLOBAL TECHNOLOGY OPERATIONS LLC, Detroit, MI (US)

(72) Inventor: Thomas JENNY, Ruesselsheim (DE)

(73) Assignee: GM GLOBAL TECHNOLOGY OPERATIONS LLC, Detroit, MI (US)

(21) Appl. No.: 15/060,891

(22) Filed: Mar. 4, 2016

(30) Foreign Application Priority Data
Mar. 5, 2015 (DE) 102015002833.2

(51) Int. Cl. B60R 21/36

(52) U.S. Cl. CPC B60R 21/36; B60R 2021/0004

(57) ABSTRACT

An airbag module is disclosed for use in a motor vehicle, with an airbag and a gas generator. In such an airbag module, the airbag includes at least one actuator area and at least one retention area. The actuator area serves to act on a component of the motor vehicle that borders the airbag module. Further proposed is a use of such an airbag module, in which the actuator area serves to act on the front hood of the motor vehicle, and the retention area serves to cover an A-pillar of the motor vechicle, or retention areas serve to cover the A-pillar and a windshield wiper area adjacent to a windshield.

### CROSS-REFERENCE TO RELATED APPLICATION

This application claims priority to German Patent Application No. 102015002833.2, filed Mar. 5, 2015, which is incorporated herein by reference in its entirety.

### TECHNICAL FIELD

The present disclosure pertains to an airbag module for use in a motor vehicle, with an airbag and a gas generator, and in particular relates to a special use of such an airbag module.

### BACKGROUND

Airbag modules include an airbag and a gas generator for filling the airbag following the deployment of the airbag module. An airbag module can additionally be equipped with a housing. However, airbag modules can definitely also he used without a housing.

Airbag modules are also used in conjunction with additional actuators. For example, pyrotechnical actuators are used to open or raise a front hood of a motor vehicle given a collision between the vehicle and a person. The front hood is opened or raised at the same time or just before an airbag module is activated, and hence the airbag is inflated.

DE 100 12 093 A1 describes a steering device for a motor vehicle with an airbag module. In this steering device, when a crash sensor detects a collision, it activates a first generator stage of a two-stage gas generator of the airbag module, displacing the gas generator from a cover for an airbag outlet opening in the area of a steering wheel hub. During this displacement, the gas generator takes along a wire rope hoist, and thereby exerts a tensile force on an edge-side cover part area, so that the cover tears open in an additional, notched cover part area, and is pivoted around a respective fixed swivel bearing displaced somewhat inwardly from the edge-side end area. Upwardly pivoting the cover partial areas in this way releases an airbag outlet opening, so that the airbag with the time delay-activated second generator stage of the two-stage gas generator can be inflated by a passage through the airbag outlet opening.

### SUMMARY

The present disclosure provides an expanded functionality of the airbag module, as well as a special use of the airbag module in a motor vehicle. The airbag module according to the present disclosure includes at least one airbag and a gas generator. The airbag here includes at least one actuator area and at least one retention area. The actuator area serves to act on a component of the motor vehicle that borders the airbag module.

It is thus essential in the airbag module according to the present disclosure that the airbag realize the functionality of actuators so as to act on the component of the motor vehicle, and the functionality of retention. As a consequence, it is not necessary to provide additional actuators, e.g., pyrotechnic actuators. Rather, actuator functionality is integrated into the airbag,

For example, the actuator area serves to directly act on the component. Alternatively, the airbag in the actuator area can be connected with a compression or tensile element in order to act on the component via the compression or tensile element. The actuator area of the airbag can contain an integrated compression or tensile element made out of another material, e.g., which can be sewn in or specifically serve to transfer forces, for example by being designed as a plate-like plastic molded part.

A structurally simple configuration for the airbag is obtained by having the latter includes a single chamber. The airbag is here preferably filled via the gas generator in such a way that gas first streams into the actuator area of the airbag. This primary filling of the airbag in the actuator area causes the latter to act on the component bordering the airbag module. After a delay at the start of filling the actuator area of the airbag, the airbag is filled in the retention area. Thus, in that area of the airbag intended to afford protection during a collision with a person. An alternative configuration provides that the airbag includes at least two interconnected chambers, and that the airbag be filled via the gas generator in such a way that gas first streams into a chamber allocated to the actuator area of the airbag. The gas then passes from this chamber allocated to the actuator area into the chamber of the airbag allocated to the retention area. As a consequence, a time-delayed filling of the actuator area and retention area takes place in this configuration as well, wherein the actuator area of the airbag is filled first.

The gas generator of the airbag module can be variously arranged, specifically inside of the airbag or outside of the airbag. The alternative selected depends in particular on the structural circumstances in the vicinity of the airbag module and the required structural outlay as relates to the airbag module.

The gas generator can be connected with the airbag in various ways. The gas generator is preferably connected with the airbag via a fabric or tubular gas guide. It is regarded as especially advantageous for the individual areas of the airbag, meaning the actuator area(s) and retention areas), to be arranged at specific angles relative to each other, with an angle of 90° relative to each other being regarded as especially advantageous. It is generally preferred that the retention or actuator areas be arranged relative to each other at an angle of 60° to 120°, preferably at an angle of 80° to 100°, in particular at an angle of 90° Arranging the areas at an angle in this way ensures optimal functionalities of the airbag module for the respective areas, i.e., the actuator area and retention area.

In a preferred exemplary embodiment, the airbag includes a single retention area and a single actuator area, wherein the two areas are arranged relative to each other at an angle of 60° to 120°, preferably at an angle of 80° to 100°, in particular at an angle of 90°. As a result, varying effective directions arise for the two areas. For example, the effective direction of the actuator area is perpendicular to the retention area given an angle of 90° between the two areas.

Another preferred exemplary embodiment provides that the airbag includes two retention areas and a single actuator area, wherein the two retention areas are arranged relative to each other at an angle of 60° to 120°, preferably at an angle of 80° to 100°, in particular at an angle of 90°. Additionally, the actuator area is arranged relative to each of the retention areas at an angle of 60° to 120°, preferably at an angle of 80° to 100°, in particular at an angle of 90°, For example, if the two retention areas form an angle of 90° relative to each other, and the actuator area forms an angle of 90° relative to the respective retention area, the effective directions of the three areas are situated perpendicularly one on top of the other.

The airbag designed as a single-chamber airbag or multi-chamber airbag can be configured with or without interior gas guiding channels and/or retaining belts. Likewise, the airbag module can be configured with or without a housing for the airbag.

The present disclosure further provides a special use of the airbag module. The airbag module is used in a motor vehicle in the area of a front hood, wherein the actuator area exerts an action by opening or raising the front hood, and the retention area serves to cover an A-pillar of the motor vehicle or the retention areas serve to cover the A-pillar and a windshield wiper area adjacent to a windshield of the motor vehicle.

In particular, the embodiment of the airbag with the single retention area and single actuator area is used for opening or raising the front hood and covering the A-pillar. The airbag configuration with the two retention areas and single actuator region is used in particular for opening or raising the front hood and covering the A-pillar and windshield wiper area adjacent to the windshield of the motor vehicle.

The airbag module can be situated in varying areas of the motor vehicle. If the airbag module interacts with a front hood of the motor vehicle, it is viewed as especially advantageous for the airbag module to be situated in a hinge area of the front hood adjacent to the windshield, below the front hood or in the water tank area (cowl area), i.e., in the area of the windshield wipers for the windshield. If a vehicle collision is detected, a crash sensor activates the gas generator, which fills the airbag. The actuator area first acts on the component of the motor vehicle bordering the airbag module, with a front hood in particular being raised so as to present the person being impacted with a larger deformation zone. After a minimal time delay, the retention area of the airbag is filled with gas. When using the airbag module in conjunction with the front hood, a single retention area is placed onto the A-pillar, and there provides the necessary protection; by contrast, when two retention areas are used, they come to lie on the A-pillar and windshield wiper area, thereby providing protection in these areas of the motor vehicle.

### BRIEF DESCRIPTION OF THE DRAWINGS

The present disclosure will hereinafter be described in conjunction with the following drawing figures, wherein like numerals donate like elements.

FIG. 1 shows a first exemplary embodiment of the airbag module with the airbag filled with gas, illustrated in a spatial representation; and

FIG. 2 shows a second exemplary embodiment of the airbag module with the airbag filled with gas, illustrated in a spatial representation.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

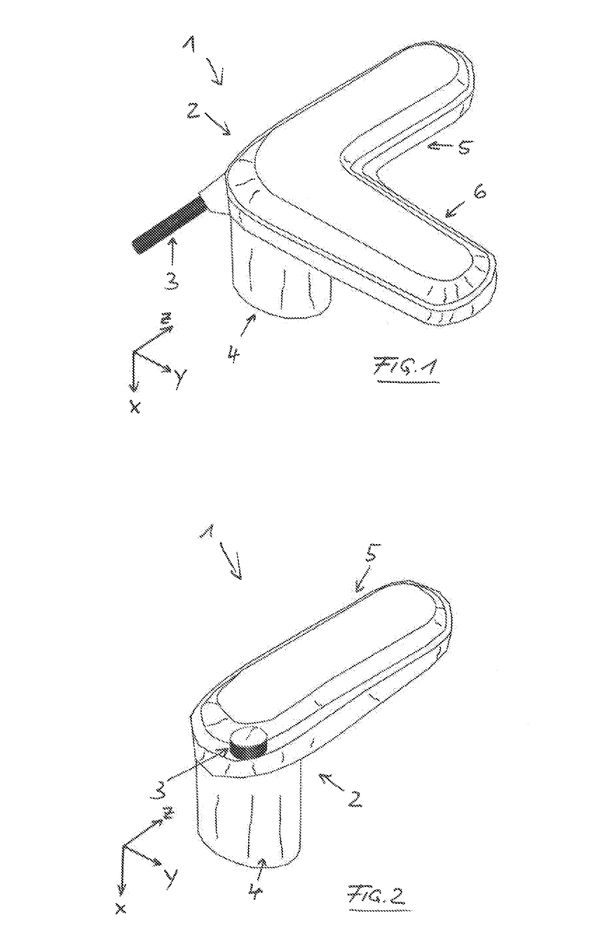

FIG. 1 illustrates an airbag module 1, which includes an airbag 2 and a gas generator 3. The airbag includes an actuator area 4, a retention area 5 and a retention area 6. The three areas 4, 5 and 6 may include one or more chambers, so that the airbag 2 is designed as a single-chamber airbag or a multi-chamber airbag. The airbag 2 is configured in such a way that, when the gas generator 3 is activated, gas initially streams predominantly into the actuator area 4 of the airbag 2, filling it completely before the airbag 2 is completely filled in the retention areas 5, 6. The retention areas 4, 5 and 6 are here situated in such a way that the two retention areas 5, 6 are arranged at an angle of 90° relative to each other. In addition, the actuator area 4 is situated at an angle of 90° relative to the respective retention area 5 or 6. The three areas 4, 5, 6 are thus each situated perpendicular to each other, thereby quasi framing a three-dimensional coordinate system x, y, z. The gas generator 3 is preferably connected with the airbag 2 in its actuator area 4, adjacent to the transition from the actuator area 4 to the retention areas 5 and 6. FIG. 1 illustrates the airbag 2 in a state filled with gas.

If the airbag 2 is filled with gas following activation of the gas generator 3, the actuator area 4 of the airbag 2 expands in the x-direction of the illustrated coordinate system, and can thus act on a component of the motor vehicle bordering the airbag 2. This component involves in particular a front hood of the motor vehicle in its hinge area. The airbag 2 that is supported between the front hood and a stationary area of the vehicle while filling the airbag 2 in the actuator area 4 thus raises the front hood somewhat in its area adjacent to the windshield, and gives a person being impacted a front hood with a larger deformation zone. A minimal time after admitting gas to fill the airbag 2 in the actuator area 4, the two retention areas 5 and 6 are filled in the direction of coordinates y, z, in particular simultaneously. The filled retention area 5 covers the motor vehicle in the area of the A-pillar, adjacent to the front hood, and the filled retention area 6 covers the area of the motor vehicle between the front hood and a water tank.

In the exemplary embodiment according to FIG. 1, the gas generator 3 is designed as a tubular gas generator, and situated outside of the airbag 2.

In the exemplary embodiment according to FIG. 2, the airbag 2 only includes a single retention area 5 in addition to the actuator area 4 so as to cover the A-pillar as described above. The airbag 2 does not include the extra retention area 6. Further, the gas generator 3 is not situated outside of the airbag 2, but inside of the airbag 2. The gas generator is designed as a disk-type gas generator. The actuator area 4 and retention area 5 are situated at an angle of 90° relative to each other. While filling the airbag 2, the actuator area 4 is first filled in the direction of the x-coordinates, after which the retention area 5 is filled in the direction of the z-coordinates.

In both embodiments, the airbag module 1 is mounted under the rear front hood or bonnet edge, or in the area of the water tank below the rear front hood or bonnet edge in front of the windshield root.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. An airbag module for use in a motor vehicle comprising an airbag and a gas generator, wherein the airbag includes at least one actuator area configured to act on an component of the motor vehicle that borders the airbag module and at least one retention area.

16. The airbag module according to claim 15, wherein the actuator area is used to raise the component of the motor vehicle bordering the airbag module from a closed position to an at least partially open position.

17. The airbag module according to claim 15, wherein the actuator area is configured to directly act on the component.

18. The airbag module according to claim 15, wherein the airbag in the actuator area is connected with an element configured to act on the component in one of tension or compression.

19. The airbag module according to claim 15, wherein the airbag comprises a single chamber configured to be filled via the gas generator in such a way that gas first streams into the actuator area of the airbag.

20. The airbag module according to claim 15, wherein the airbag comprises at least two interconnected chambers, and the airbag is filled via the gas generator in such a way that gas streams into a first chamber allocated to the actuator area of the airbag and then into a second chamber.

21. The airbag module according to claim 15, wherein the gas generator is situated inside of the airbag,

22. The airbag module according to claim 15, wherein the gas generator is situated outside of the airbag.

23. The airbag module according to claim 22, further comprising a tubular gas guide in fluid communication between the gas generator and the airbag.

24. The airbag module according to claim 23, wherein the tubular gas guide comprises a fabric gas guide.

25. The airbag module according to claim 15, wherein the actuator and retention area are arranged relative to each other at an angle in the range of 60° to 120°.

26. The airbag module according to claim 25, wherein the actuator and retention area are arranged relative to each other at an angle of about 90°.

27. The airbag module according to claim 15, wherein the airbag comprises a single retention area and a single actuator area, wherein the retention and actuator areas are arranged relative to each other at an angle in the range of 60° to 120°.

28. The airbag module according to claim 15, wherein the airbag comprises first and second retention areas and a single actuator area, wherein the first and second retention areas are arranged relative to each other at an angle in the range of 60° to 120°

29. The airbag module according to claim 15, wherein the airbag comprises first and second retention areas and a single actuator area, wherein the first and second retention areas are arranged relative to each other at an angle of about 90°.

30. The airbag module according to claim 15, wherein the airbag comprises an interior gas-guiding channel

31. The airbag module according to claim 15, wherein the airbag comprises a retaining belt.

32. The airbag module according to claim 15, further comprising a housing for the airbag.

33. A motor vehicle comprising a front hood and an airbag module according to claim 15, wherein the actuator area is configured to act on the front hood for opining and raising the front hood, and the retention area is configured to cover an A-pillar of the motor vehicle

34. A motor vehicle comprising a front hood and an airbag module according to claim 15, wherein the actuator area is configured to act on the front hood for opining and raising the front hood, and one retention area is configured to cover the A-pillar and another retention area is configured to cover a windshield wiper area adjacent to a windshield of the motor vehicle.
